(19) United States
(12) Patent Application Publication
(10) Pub. No.: US 2010/0024310 A1
(43) Pub. Date: Feb. 4, 2010

(54) Polycrystalline Aluminum-Containing Grits and Associated Methods

(76) Inventor: Chien-Min Sung, Tansui (TW)

Correspondence Address: THORPE NORTH & WESTERN, LLP., P.O. Box 1219, SANDY, UT, 84091-1219, US

(21) Appl. No.: 12/512,900

(22) Filed: Jul. 30, 2009

Related U.S. Application Data
(60) Provisional application No. 61/084,837, filed on Jul. 30, 2008.

(51) Int. Cl. C09K 3/14; B24D 3/00

(52) U.S. Cl. 51/295; 51/309

(57) ABSTRACT

A method of forming a composite polycrystalline aluminum containing grit can include forming a dispersion of alumina and gelling the dispersion of alumina to form a gel. A nitride abrasive particle can be added to either the dispersion of alumina or the gel. After the nitride abrasive particle has been added, the gel can be processed to form a composite polycrystalline alumina nitride grit.

### PRIORITY DATA

This application claims the benefit of U.S. Provisional Patent Application Ser. No. 61/084,837, filed on Jul. 30, 2008, which is incorporated herein by reference.

### FIELD OF THE INVENTION

The present invention relates to methods for use in connection with producing abrasive particles. More particularly, the present invention relates to polycrystalline aluminum-containing grits and accompanying methods for making such grits. Accordingly, the present invention involves the fields of chemistry, metallurgy, materials science, and high pressure technology.

### BACKGROUND OF THE INVENTION

Abrasive particles have long been used in numerous applications, including cutting, drilling, sawing, grinding, lapping and polishing of materials. A wide variety of abrasive particles can be used, depending on the specific application and workpiece. Typically, extraordinarily hard abrasive particles such as diamond and cubic boron nitride (cBN) are referred to as superabrasive particles. Non-superabrasive particles, tend to have a toughness and hardness significantly less than superabrasive particles. Additionally, the price difference between superabrasive particles and non-superabrasive particles tends to be significant. Leaving a gap in performance and cost between superabrasive particles and non-superabrasive particles.

Abrasive grits, once formed, can be further processed to form various products. For example, abrasive grits can be pulverized to form smaller abrasive fines, e.g., as small as about 0.1 μm. Alternatively, micron powder of certain abrasive grits can be sintered to form larger abrasive bodies such as compacts. These larger compacts are often supported by a substrate to reinforce their impact strength.

The cutting and material removal properties of single crystal particles and polycrystalline bodies can differ considerably. Specifically, polycrystalline bodies have randomly oriented microscopic grains corresponding to individual grains. This makes the polycrystalline bodies more impact resistant than single crystal particles, which tend to fracture along cleavage planes and often results in shattering or failure of the entire single crystal particle as a useful abrasive particle. Further, as polycrystalline bodies fracture on a microscale, the fractures expose new sharp edges and help to maintain abrasive properties over a longer useful life.

A number of methods have been developed to produce alumina and polycrystalline alumina grits. One method is known as the sol-gel method, and the product known as sol-gel alumina grits. In this method, a sol or dispersion is first formed with alumina. The sol is then gelled and further dried and sintered to form individual grits. In order to form grits that function well as abrasives, the alumina is generally guarded against impurities throughout the processing. One modification of the sol-gel process is adding seeds to act as centers of nucleation of the alumina. α-alumina seeds are used for their effectiveness and as they do not introduce impurities into the system. It should be noted, however, that a limited amount of impurities may be added to the sol-gel alumina to affect processing, and in such times the type and amount is carefully selected so as to limit adverse effects to the resulting grit or compact. For example, iron oxide powder may be added to suppress the grain growth of alumina crystals.

As such, methods and materials for improved abrasive grits and methods of producing them continue to be sought.

### SUMMARY OF THE INVENTION

Accordingly, the present invention provides a method for forming polycrystalline grits that have hardness and/or toughness in the range between abrasive and superabrasive grits. A method of forming a composite polycrystalline aluminum containing grit, can include forming a dispersion of alumina, gelling the dispersion of alumina to form a gel, adding a nitride abrasive particle to either the dispersion of alumina or the gel, and finally processing the gel to form a composite polycrystalline alumina and nitride grit.

Likewise, a composite alumina polycrystalline grit can be formed that includes alumina and nitride in a polycrystalline abrasive particle. The nitride abrasive particle can be bonded to the polycrystalline alumina. Similarly, a composite polycrystalline grit can comprise a composite of crystalline alumina and crystalline cubic boron nitride.

Furthermore, a method of imparting superabrasive characteristics to a sol-gel formed polycrystalline alumina particle is herein presented. The method includes compositing a nitride abrasive particle with the polycrystalline alumina particle during sol-gel formation thereof.

The methods and resulting particles herein allow for the formation of hybrid grits wherein individual grits contain toughness and/or hardness greater than abrasive particles, however can be produced with less expensive materials, and therefore are not as expensive as abrasive particles.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a processing step” includes one or more of such steps and reference to “a nitride” includes reference to one or more of such materials.

### DEFINITIONS

In describing and claiming the present invention, the following terminology will be used in accordance with the definitions set forth below.

As used herein, “polycrystalline grits” refers to small particulates having multiple crystalline structures. Typically, the polycrystalline grits are a mass of sintered single crystals (or smaller polycrystalline crystals). Further, the term “grits” indicates a particle size within a range that is well known to those of ordinary skill in the art. However, in some aspects, such particles are most often less than about 2 mm. This is in contrast to larger polycrystalline compacts that can be up to several centimeters across and tens of millimeters thick.

As used herein, “substantially unaltered surface” refers to a particle surface that has not been modified subsequent to sintering. However, post-sintering processes such as cleaning, milling to remove burrs, reactions with atmospheric elements such as oxidation, or the like may optionally be useful for improving the quality of the final grits while also leaving substantially unaltered surfaces. For example, a substantially unaltered surface exists substantially as produced during sintering of a sol-gel alumina containing grit. Cutting or crushing processes such as laser, wire EDM, and the like can introduce artifacts and surface irregularities which are not found in substantially unaltered surfaces. Thus, a grit having a substantially unaltered surface indicates an absence of post-sintering processes such as cutting, crushing, chemical leaching, or the like which substantially alter the surfaces of the grit.

As used herein, the term “sol-gel” references the process known in the art wherein a sol or dispersion is first formed with alumina. The sol is then gelled and further dried and sintered to form individual grits.

As used herein, the term “bonding” refers to one or both of physical bonding and/or chemical bonding. “Physical bonding” references the holding of two substances together due to morphology, applied pressure, friction, etc. “Chemical bonding” refers to any bonding that is more than mere mechanical forces, including ionic bonding, covalent bonding, and any combination thereof. It therefore includes van der Waal's forces, magnetic attraction, polar covalent bonding, metallic bonding, etc.

As used herein, “seeds” when referring to use in a sol-gel process are materials, known in the art, that act as nucleation agents in polycrystalline alumina formation by addition to one or both of the sol or gel. Generally, seeds are alumina particles, and more specifically, seeds are α-alumina particles.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 micrometer to about 5 micrometers” should be interpreted to include not only the explicitly recited values of about 1 micrometer to about 5 micrometers, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value. Furthermore, such an interpretation should apply regardless of the breadth of the range or the characteristics being described.

### INVENTION

In accordance with an aspect of the present invention, a method of forming composite polycrystalline aluminum containing grit can include forming a dispersion of alumina. The dispersion of alumina can be gelled to form a gel. Nitride abrasive particle can be added to either the dispersion of alumina or the gel. Once nitride has been added to at least one of the dispersion or gel, the gel can be processed to form a composite polycrystalline alumina and nitride grit. The grits can be formed into various shapes and sizes by pre-forming the gel prior to further processing. It is efficient to form multiple grits at a time, however, each grit resulting from the presently taught is a composite polycrystalline alumina and nitride grit.

In one aspect, the further processing of the gel can include any number processes including shaping, drying, sintering, etc. The shaping can include forming layers of gel or dehydrated gel, or forming individual grit shapes of the gel or dehydrated gel. The shaping can be performed using any techniques known in the art for shaping or forming layers or grits.

Seeds may optionally added to the dispersion of alumina or the gel. The seeds act as a nucleation site within the material and function to lower the necessary sintering point of the alumina material. In one aspect, the seeds can be alumina particles. In a more specific aspect, the seeds can be α-alumina particles. Other additives known in the art can be added to the sol to enhance grain structure of the polycrystalline alumina, such as magnesium oxide, other metal oxides, mullite, etc. These additives do not bond with the alumina material, and are limited in amount so as to affect the alumina structure only as needed.

Nitride abrasive particle is added to at least one of the dispersion of alumina or the gel. In one aspect of the present invention, the nitride abrasive particles can be any nitride which can be useful for removing materials from a workpiece. Non-limiting examples of nitrides that can be utilized include boron nitride, aluminum nitride, silicon nitride, titanium nitride, and combinations thereof. In one embodiment, the nitride is or includes cubic boron nitride. The nitride abrasive particles, in one embodiment, can have an average particle size of less than about 250 microns. Alternatively, each nitride abrasive particle can have a particle size of less than about 250 microns. Nitride abrasive particle can be added in an amount sufficient to increase at least one of the hardness or toughness of the resulting composite grit. In one embodiment, the nitride abrasive particle can be added at a level of about 1 vol % to about 50 vol %. In another embodiment, the nitride abrasive particle can be added at a level of about 3 vol % to about 35 vol %. In still another embodiment, the nitride abrasive particle can be added at a level of about 5 vol % to about 25 vol %, or even at a level of about 10 vol % to about 20 vol %. In a further embodiment, the nitride can be present in an amount of less than about ⅓ of the volume of the grit. More than one nitride abrasive particle can be used in various combinations. A second, third, or even fourth nitride abrasive particle can be added independently to either the dispersion of alumina or the gel or both. In one aspect, less than about 10 vol % of a second nitride abrasive particle can be included in the composite alumina polycrystalline grit. Furthermore, it is believed that in at least one instance, the nitride added to the dispersion or gel of alumina functions as at least a partial seed material.

The resulting composite alumina polycrystalline grit, including alumina and nitride in a polycrystalline abrasive particle, can have nitride abrasive particles bonded to the polycrystalline alumina. It is believed that the addition of the nitride abrasive particle to the sol-gel process prior to sintering, i.e. while sol or gel, to form polycrystalline alumina composite grits causes the bonding. The bonding may be physical bonding. The physical bonding formed from the present method is a closer and tighter formation than would be possible by melding or sintering separate grits of nitride abrasives and alumina abrasives, as the dispersion and/or gel form of the alumina allows for tighter arrangement of the alumina up to and around the nitride grit, thus improving the physical bonding. Furthermore or in the alternative, the nitride can chemically bond to the polycrystalline alumina. Such bonding is likely due to interactions between the boron, aluminum, silicon, and/or titanium of the nitride with the oxygen of the alumina, such as is particularly prevalent at high temperatures, i.e. sintering conditions. The chemical interactions between the nitride and the alumina can be the result of covalent attractions, ionic attractions, or a mixture of both covalent and ionic attractions. The strength and character of the bond is dependent, at least in part, on the particular nitride or nitrides utilized.

The resulting polycrystalline alumina composite grits can have a hardness greater than that of a pure polycrystalline alumina grit, sol-gel type or otherwise. The added hardness is due to the presence of the nitride grit, and the bonding of the nitride grit to the polycrystalline alumina material. In one aspect, the hardness of the composite polycrystalline alumina grit can be about 5% greater than the hardness of a pure polycrystalline alumina grit. In another aspect, the hardness of the composite polycrystalline alumina grit can be about 10% greater than the hardness of a pure polycrystalline alumina grit, or even about 20% greater. In a particular embodiment, the hardness of the composite polycrystalline alumina grit can be about 5% to about 50% greater than the hardness of a pure polycrystalline alumina grit. In another embodiment, the hardness of the composite polycrystalline alumina grit can be about 10% to about 40% greater than the hardness of a pure polycrystalline alumina grit. In still another embodiment, the hardness of the composite polycrystalline alumina grit can be about 15% to about 30% greater than the hardness of a pure polycrystalline alumina grit. Furthermore, the resulting polycrystalline alumina composite grits can have a toughness greater than that of a pure polycrystalline alumina grit, sol-gel type or otherwise. The improved hardness and/or toughness can be a result of the type of nitride utilized, quality of material used throughout the grit, processing conditions, and relative amounts of each material. In one aspect, the toughness of the composite polycrystalline alumina grit can be about 5% greater than the toughness of a pure polycrystalline alumina grit. In another aspect, the toughness of the composite polycrystalline alumina grit can be about 10% greater than the toughness of a pure polycrystalline alumina grit, or even about 20% greater. In a particular embodiment, the toughness of the composite polycrystalline alumina grit can be about 5% to about 50% greater than the toughness of a pure polycrystalline alumina grit. In another embodiment, the toughness of the composite polycrystalline alumina grit can be about 10% to about 40% greater than the toughness of a pure polycrystalline alumina grit. In still another embodiment, the toughness of the composite polycrystalline alumina grit can be about 15% to about 30% greater than the toughness of a pure polycrystalline alumina grit. Such modification to various compositions and selection of material would be within the purview of one of ordinary skill in the art.

As noted, compositions and materials utilized can vary. In one aspect, the polycrystalline alumina portion of the composite grit can have an average grain size of less than about 5 microns. Various additives may be utilized to alter the grain size, as may processing conditions. In one embodiment, greater than about 40 vol % of the composite grit can be polycrystalline alumina. Prior to use in the described methodology, the nitride particles can be cleaned, if necessary. This can help to improve quality, and thus the toughness and hardness of resulting grits by removing foreign material which can interfere with contact and growth of particles during processing.

The gel, including nitride grit is processed to form a composite polycrystalline alumina and nitride grit. The processing can include a number of separate processing steps. In one aspect, processing can include further drying the gel and/or subjecting the gel or dried gel to calcination. Such drying can occur at a temperature from about 80° C. to about 200° C., or more specifically from about 100° C. to about 150° C. Calcination can generally occur at an elevated temperature from about 600° C. to about 800° C., or from about 650° C. to about 750° C. If the calcined material is in the shape of a layer, it can then be pulverized to a desired size using any known pulverizing method and equipment. If the calcined material is a pre-shaped body, the body can be recovered. The pulverized material or the pre-shaped calcined body can be sintered at a temperature from about 1100° C. to about 1300° C. The sintered grits can then be harvested, producing individual sintered grits. Such harvesting can include removal from a substrate via a number of methods including mechanical and/or chemical separation. The resulting sintered product is corundum-based composite grit having improved properties compared to pure corundum grit. It should be noted that various modifications can be made to the further processing step so as to achieve a composite grit wherein the alumina is polycrystalline and bonded to nitride.

The gel material can be formed into a layer or into individual grit precursors. The grit precursors can have a designed three-dimensional shape. The precursors can be formed having a variety of designed three-dimensional shapes such as, but not limited to, cubic, rectangular prism, blocks, pyramids, cylinder, combinations thereof, or the like. As such, the precursors can have cross-sectional shapes such as square, rectangular, circular, elliptical, triangular, pentagonal, hexagonal, or the like. Most often, desirable shapes include edges which can be useful in abrasive applications. Specific examples of suitable three-dimensional shapes can include cubes, rectangular blocks, triangular blocks, pentagonal blocks, or the like.

A variety of methods known in the art can be utilized to form individual grit precursors, including use of a template. Regardless of the method used to form the grit precursors, the arrangement of the precursors can involve a wide variety of spacings and precursor shapes. Typically, the precursors can be spaced having a pitch (center-to-center distance) which is about three times that of the precursor diameter. In another aspect, the edge-to-edge distance between precursors can be from about 1 to about 10 times the diameter of the precursors. The spacing between precursors is generally a compromise between yield of abrasive polycrystalline grits and quality of the abrasive polycrystalline grits. Specifically, as the precursors are placed closer together, there is a greater risk that adjacent grits will grow together. Those skilled in the art can choose materials and conditions which can minimize this affect based on the teachings disclosed herein.

In an additional aspect, the layer of gel and/or individual precursors can be formed or arranged on a substrate prior to sintering. The substrate can be any suitable material which can be useful to retain the precursors in the desired arrangement during formation of the precursors and sintering of the abrasive particles. The substrate can be formed of any material which has sufficient integrity to allow formation of abrasive precursors thereon. Thus, almost any material can be suitable including, but not limited to, metal foils, metal plates, films, polymeric sheets, paper, or the like. Suitable substrates can comprise a metal or non-metal material, generally provided in the form of a thin disk or sheet. Non-limiting examples of suitable substrate materials may include cobalt, nickel, iron, copper, sodium chloride, hexagonal boron nitride, graphite, stainless steel, and alloys, mixtures, or composites thereof Typically, the substrate can have a thickness from about 30 μm to about 500 μm, although thicknesses outside this range can also be used. For convenience in processing, the substrate can be provided as a single sheet which is then cut or otherwise separated into smaller segments subsequent to formation of the gel layer or precursors thereon. The smaller segments can be sized for placement in a particular high pressure device. Optionally, the substrate can be cut into smaller segments prior to formation of abrasive precursors thereon.

In one embodiment, a layer of gel can be formed and subsequently subjected to calcination, it can then be broken up using any known method to form grit precursors which can then be sintered. The final composite grit includes both polycrystalline alumina and nitride materials.

In accordance with one aspect of a method of the present invention, the precursor assembly can be placed in a device capable of sintering the abrasive particles to form an assembly of sintered polycrystalline grits. Any device which is capable of producing sufficiently high temperatures to cause sintering of the alumina particles can be used.

In another aspect of a method of the present invention, the recovered composite polycrystalline grits can have substantially unaltered surfaces such that the recovered polycrystalline grits can be used in abrasive applications without further modification of surfaces of the polycrystalline grits. Typically, the polycrystalline grits can be substantially unchanged in shape, surface roughness, and/or other properties by the recovery process. Additional cleaning steps can sometimes be required to remove residual debris, metals, or pressure medium from the polycrystalline grits. However, such cleaning steps typically do not change the shape, surface properties, or integrity of the polycrystalline grits.

A wide range of polycrystalline grit sizes and shapes can be produced, as discussed in connection with formation of the abrasive precursors. Typically, the polycrystalline grits can have an average size from about 18 mesh (about 1 mm) to about 400 mesh (37 microns), depending on the specific intended application. The methods of the present invention further allow production of large amounts of polycrystalline grits having highly uniform size distributions. In accordance with the present invention, the polycrystalline grits can have substantially uniform sizes and shapes to within several micrometers.

In accordance with the present invention, the polycrystalline grits can have substantially uniform shapes and sizes. Additionally, substantially uniform composite polycrystalline grits can improve performance in abrasive applications by allowing for microfracturing of the grits rather than macrofracturing. Specifically, the polycrystalline structure allows small portions of the grit to fracture without causing catastrophic failure of the entire grit. Additionally, the constant microfracturing of each grit allows for a continual renewal of sharp edges on the grit which helps to maintain cutting speed. Further, polycrystalline grits of the present invention tend to be relatively rough as compared to single crystal grits. This increased roughness allows for improved bonding with various tools.

In a particular embodiment, a composite polycrystalline grit can include a composite of crystalline alumina and crystalline cubic boron nitride. In a further embodiment, the composite grit can include from about 0.1 vol % to about 10 vol % of a nitride selected from the group consisting of aluminum nitride, silicon nitride, titanium nitride, and combinations thereof.

Likewise, a method of imparting superabrasive characteristics, such as e.g., improved hardness and/or toughness, can include compositing a nitride abrasive particle within the polycrystalline alumina particle during sol-gel formation thereof Optionally, the nitride abrasive particle can include cubic boron nitride having a particle size of less than about 250 microns.

The composite polycrystalline grits resulting from the methods presented herein are capable of embodying superabrasive characteristics, but without the added material expense. Such unique abrasives fill in the gap of abrasive particles between superabrasive and non-superabrasive. The methodology introduces the composite materials, specifically, the alumina and the nitrate in such an intimate manner during the sol-gel process so as to form bonding, and thus a impact the physical properties of the resulting grit.

The formed grits can be utilized in a number of applications, including forming abrasive compacts and other abrasive machinery. It should be noted that while it is known to mix grits of alumina or polycrystalline alumina with nitride grits such as cubic boron nitride to form a compact or vitrified tool, such is not the same as an individual grit containing both alumina and nitride. Nor would a resulting compact of the grits described herein have the same properties as a compact formed of a mixture of alumina grits with cubic boron nitride grits. Again, the intricate nature of including nitride grit during sol-gel formation of polycrystalline alumina causes physical interlocking or embedding of the nitride grit, and likely chemical bonding, thus forming a much more compatible and strengthened association of materials than could be found by a simple mixture and vitrification of individual grits into a compact.

Another application of the grits is in cutting tools, such as those including shanks and holders. A method of forming a cutting tool, for example, can include brazing one or more composite grits to a substrate or other portion of a cutting tool. In a specific embodiment, a method of forming a cutting tool can include coating a one or more composite alumina polycrystalline grits with a pre-braze coating, such as titanium. The coated grits can be embedded in a braze powder in a depression of a tool shank. The braze can be melted, thus bonding the grits to the tool shank. The shank can have a holder, as is known in the art. A sharp corner of one or more composite grits can be exposed, for example, by grinding and/or polishing.

The following example illustrates methods of making composite polycrystalline alumina grits in accordance with the present invention. However, it is to be understood that the following are only exemplary or illustrative of the application of the principles of the present invention. Numerous modifications and alternative compositions, methods, and systems can be devised by those skilled in the art without departing from the spirit and scope of the present invention. The appended claims are intended to cover such modifications and arrangements. Thus, while the present invention has been described above with particularity, the following Examples provide further detail in connection with several specific embodiments of the invention.

### EXAMPLE

Bauxite and alkoxide are mixed and milled to less than about 400 mesh. NaHO and H₂O are added. Boehmite (AlOOH) is subsequently added to the mixture and a sol is formed. cBN having a size of about 1 μm is added along with a mixture of AN and Si₃N₄. Seeds of α-alumina, and oxide additives of Fe₂O₃ and Mn₂O₃, each having a size of less than 50 nm, are added to the mix. Optionally, other oxides could be utilized, such as MgO, TiO₂, ZrO₂, Y₂O₃, La₂O₃, Nd₂O₃, and combinations thereof The combination is then mixed. Mg(NO₃)₂ is then added and the mixture undergoes evaporation to a gel. The gel is layered on a substrate and dried at about 120° C., and then calcined at 700° C. The calcined layer is then pulverized and sieved to the desired size, wherein all non-conforming particles can be appropriately recycled back into the process (i.e. oversized pulverized again, undersized back to milling with the bauxite and alkoxide). The particles having the appropriate size can then be sintered at around 1200° C. to form corundum.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of forming a composite polycrystalline aluminum containing grit, comprising:
forming a dispersion of alumina;
gelling the dispersion of alumina to form a gel;
adding a nitride abrasive particle to either the dispersion of alumina or the gel; and
processing the gel to form a composite polycrystalline alumina and nitride grit.

2. The method of claim 1, wherein the step of processing the gel includes drying and sintering.

3. The method of claim 1, further comprising the step of adding seeds to either the dispersion of alumina or the gel.

4. The method of claim 1, wherein the nitride abrasive particle is selected from the group consisting of cubic boron nitride, aluminum nitride, silicon nitride, titanium nitride and combinations thereof

5. The method of claim 1, wherein the nitride abrasive particle has a particle size of less than about 250 microns.

6. The method of claim 1, further comprising adding a second nitride abrasive particle to either the dispersion of alumina or the gel.

7. A composite alumina polycrystalline grit, comprising alumina and nitride in a polycrystalline abrasive particle, wherein the nitride abrasive particle is bonded to the polycrystalline alumina.

8. The composite alumina polycrystalline grit of claim 7, wherein the grit has a hardness greater than a hardness of a grit of pure polycrystalline alumina.

9. The composite alumina polycrystalline grit of claim 7, wherein the grit has a toughness greater than a toughness of a grit of pure polycrystalline alumina.

10. The composite alumina polycrystalline grit of claim 7, wherein the bonding includes mechanical bonding.

11. The composite alumina polycrystalline grit of claim 7, wherein the bonding includes chemical bonding.

12. The composite alumina polycrystalline grit of claim 7, wherein the nitride is selected from the group consisting of cubic boron nitride, aluminum nitride, silicon nitride, titanium nitride, and combinations thereof.

13. The composite alumina polycrystalline grit of claim 7, wherein the nitride is present in less than about ⅓ of the volume of the grit.

14. The composite alumina polycrystalline grit of claim 7, wherein a polycrystalline alumina portion of the composite grit has an average grain size of less than about 5 microns.

15. The composite alumina polycrystalline grit of claim 7, wherein greater than about 40 vol % of the grit is polycrystalline alumina.

16. The composite alumina polycrystalline grit of claim 7, further comprising less than about 10 vol % of a second nitride abrasive particle.

17. A cutting tool comprising the composite alumina polycrystalline grit of claim 7, a shank, and a holder.

18. A method of forming a cutting tool, comprising:
coating a plurality of composite alumina polycrystalline grits of claim 7 with titanium;
embedding the coated grit in a depression of a tool shank, wherein the grit is embedded in braze powder;
melting the braze powder sufficient to bond the grit to the tool shank; and
exposing a sharp corner of at least one grit.

19. A composite polycrystalline grit, comprising a composite of crystalline alumina and crystalline cubic boron nitride.

20. A method of imparting superabrasive characteristics to a sol-gel formed polycrystalline alumina particle, comprising compositing a nitride abrasive particle with the polycrystalline alumina particle during sol-gel formation thereof.
